(19) United States
(12) Patent Application Publication
(10) Pub. No.: US 2009/0100494 A1
(43) Pub. Date: Apr. 16, 2009

(54) SYSTEM AND METHOD FOR CONTROLLING PLAYLIST ENTRY SELECTION

(76) Inventor: Michael D. Teal, Clayton, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/872,257

(22) Filed: Oct. 15, 2007

(51) Int. Cl. H04N 7/173

(52) U.S. Cl. 725/134

(57) ABSTRACT

A playback selection feature of an electronic device is disclosed. The playback selection feature enhances the ability of a user to control the manner in which audiovisual files are played back using the electronic device. In one implementation, the playback selection feature allows a user to scroll through a playlist and select a desired entry for playback. Playback of the selected entry may commence after playback of an entry that is currently being played back ends.

### TECHNICAL FIELD OF THE INVENTION

The technology of the present disclosure relates generally to playing back audiovisual content with an electronic device and, more particularly, to a system and method for allowing a user to temporarily override normal playlist operation.

### BACKGROUND

Mobile and/or wireless electronic devices are becoming increasingly popular. For example, mobile telephones, portable media players and portable gaming devices are now in wide-spread use.

Many of these devices may store audio files and play the files back for listening by a user. But playback controls tend to be limited to a set number of functions, such as sequentially playing audio files back in a predetermined order or playing audio files back in a random order.

### SUMMARY

To enhance the ability of a user to control the manner in which audiovisual files are played back using an electronic device, the present disclosure describes an improved playback function. The playback function allows a user to scroll through a playlist and select a desired entry for playback. Playback of the selected entry may commence after playback of an entry that is currently being played back ends. The disclosed technique advantageously allows the user to select an entry for playback without stopping play of a current entry and without the creation of an alternative playlist. A simple and intuitive user interface is disclosed so that the user may make a selection without leaving a screen that shows a currently active playlist (sometime referred to as a “now playing” screen).

According to one aspect of the disclosure, a method of controlling playback of audiovisual content using an electronic device includes displaying a playlist having a plurality of entries that are each associated with an item of audiovisual content and wherein one of the items of audiovisual content is undergoing current playback; receiving user input to identify and select a target entry from the playlist; and immediately following completion of the playback of the currently playing item of audiovisual content, playing back the item of audiovisual content associated with the target entry.

According to one embodiment, the method further includes completing playback of the item of audiovisual content associated with the target entry; and playing back additional items of audiovisual content that correspond to entries from the playlist after playback of the item of audiovisual content associated with the target entry.

According to one embodiment of the method, the playback of additional items of audiovisual content starts with an item of audiovisual content having an associated playlist entry that falls in a predetermined playback order of the playlist immediately after the entry corresponding to the item of audiovisual content played before the item of audiovisual content associated with the target entry was played.

According to one embodiment of the method, the predetermined playback order is a sequential queue.

According to one embodiment of the method, the predetermined playback order is a random order.

According to one embodiment of the method, the playback of additional items of audiovisual content starts with an item of audiovisual content having an associated playlist entry that falls in a predetermined playback order of the playlist immediately after the target entry.

According to one embodiment of the method, during playback of the additional items of audiovisual content, the item of audiovisual content associated with the target entry is skipped from playback.

According to one embodiment, the method further includes displaying a menu with a menu option to play the identified entry next as a means for the user to make the selection.

According to one embodiment, the method further includes cancelling playback of the item of audiovisual content associated with the target entry following receipt of user input to command the cancelling.

According to another aspect of the disclosure, a program is stored on a machine readable medium and is written to control playback of audiovisual content using an electronic device. The program may include logic to control the display of a playlist, the playlist having a plurality of entries that are each associated with an item of audiovisual content; logic to receive user input to identify and select a target entry from the playlist during playback of one of the items of audiovisual content; and logic to control the playback of the items of audiovisual content so that immediately following completion of the playback of the currently playing item of audiovisual content, the item of audiovisual content associated with the target entry is played back.

According to one embodiment, the program further includes logic to complete playback of the item of audiovisual content associated with the target entry; and logic to control the playback of additional items of audiovisual content that correspond to entries from the playlist after playback of the item of audiovisual content associated with the target entry.

According to one embodiment, the program further includes logic to display a menu with a menu option to play the identified entry next as a means for the user to make the selection.

According to another aspect of the disclosure, an electronic device includes a display; and a control circuit that is configured to control playback of audiovisual content, including control the display of a playlist on the display, the playlist having a plurality of entries that are each associated with an item of audiovisual content; receive user input to identify and select a target entry from the playlist during playback of one of the items of audiovisual content; and control the playback of the items of audiovisual content so that immediately following completion of the playback of the currently playing item of audiovisual content, the item of audiovisual content associated with the target entry is played back.

According to one embodiment, the electronic device further includes call circuitry to establish a call over a network.

According to one embodiment of the electronic device, the control circuit is further configured to complete playback of the item of audiovisual content associated with the target entry and control the playback of additional items of audiovisual content that correspond to entries from the playlist after playback of the item of audiovisual content associated with the target entry.

According to one embodiment of the electronic device, the control circuit is further configured to display a menu with a menu option to play the identified entry next as a means for the user to make the selection.

According to another aspect of the disclosure, a method of controlling playback of audiovisual content using an electronic device includes identifying a target entry from a displayed playlist, the playlist having a plurality of entries that are each associated with an item of audiovisual content and wherein one of the items of audiovisual content is undergoing current playback; and selecting the target entry for immediate playback after playback of the currently playing item of audiovisual content concludes.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device that includes a playback selection feature;

FIG. 2 is a schematic block diagram of the mobile telephone of FIG. 1;

FIG. 3 is a schematic diagram of a communications system in which the mobile telephone of FIG. 1 may operate;

FIGS. 4 through 8 are exemplary screen shots of a user interface from which a user of the electronic device may control the playback selection feature.

### DETAILED DESCRIPTION OF EMBODIMENTS

Embodiments will now be described with reference to the drawings, wherein like reference numerals are used to refer to like elements throughout. It will be understood that the figures are not necessarily to scale.

In this document, embodiments of a playback selection feature are described primarily in the context of a mobile telephone. It will be appreciated, however, that the exemplary context of a mobile telephone is not the only type of electronic device that may include the disclosed functions. These functions may be incorporated into any type of appropriate electronic device, examples of which include a media player, a gaming device and a computer. Also, the interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

The term “audiovisual content” broadly refers to any type of audio-based and/or video-based subject matter and may be take the form of a stored file or data obtained over a communications link (e.g., streaming data or downloaded data). Stored files may include, for example, an image file (e.g., a photograph), a music file (e.g., a song), a ring tone, a video file, and so forth and may be stored locally by a memory of the electronic device or remotely, such as by a server. Streaming data may relate to a service that delivers audio and/or video for consumption by the electronic device and may include, for example mobile radio channels or mobile television channels.

In this document, embodiments of the playback selection feature are described primarily in the context of playing back songs where each song is embodied by a corresponding audio file. It will be understood that the playback selection feature may be used to control playback of other types of audiovisual content, such as video files. Also, each content item does not need to be stored in its own file.

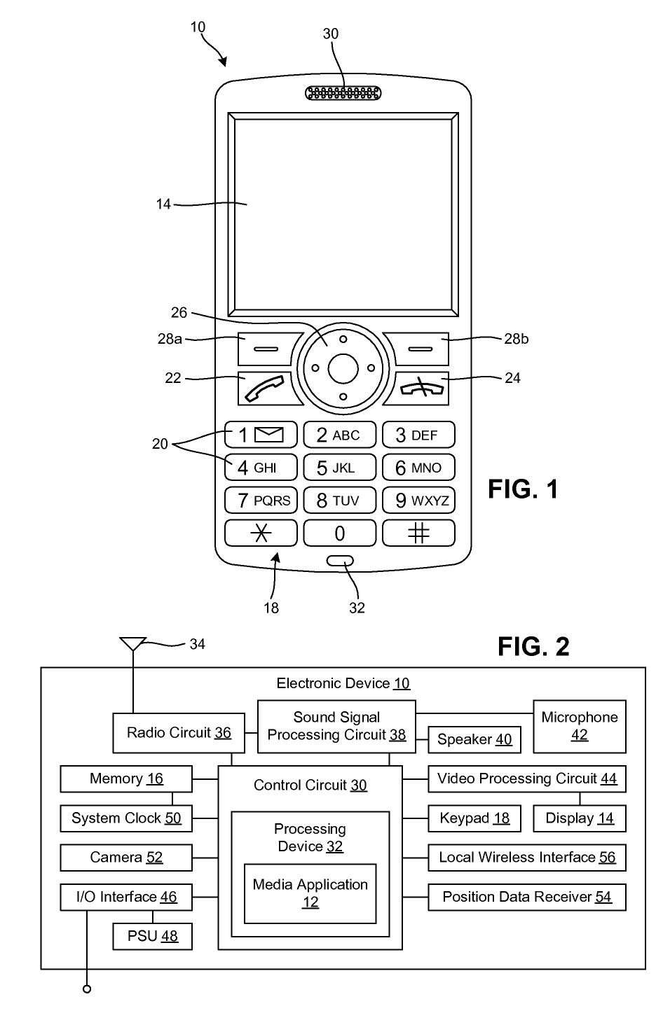

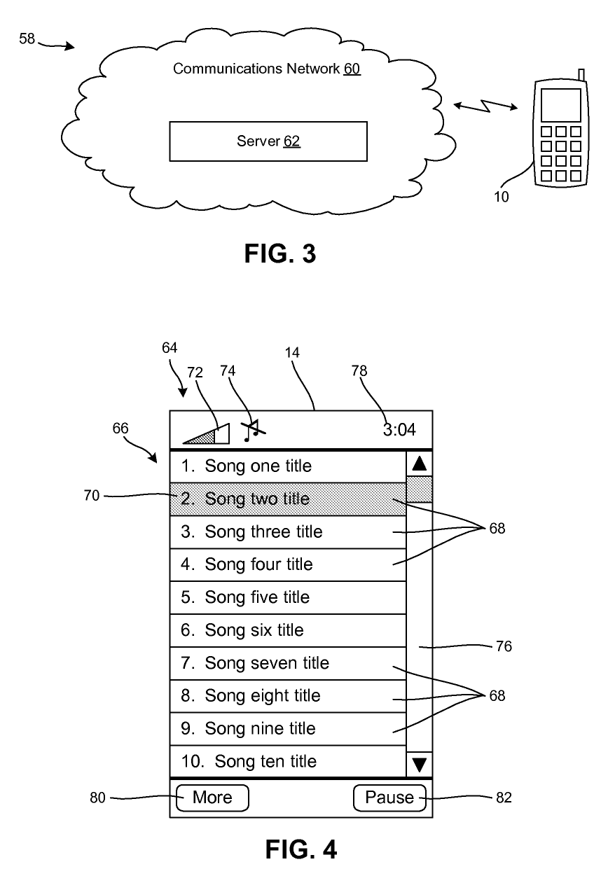

Referring initially to FIGS. 1 and 2, an electronic device is shown. The electronic device 10 includes a media application 12 that is configured to facilitate selection of an item of audiovisual content to be played following the completion of a currently playing item of audiovisual content. Additional details and operation of the media application 12 will be described in greater detail below. The media application 12 may be embodied as executable code that is resident in and executed by the electronic device 10. In one embodiment, the media application 12 may be a program stored on a computer or machine readable medium. The media application 12 may be a stand-alone software application or form a part of a software application that carries out additional tasks related to the electronic device 10.

The electronic device 10 of the illustrated embodiment is a mobile telephone. The exemplary mobile telephone is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The electronic device 10 may include a display 14. The display 14 displays information to a user such as operating state, time, telephone numbers, contact information, various menus, etc., that enable the user to utilize the various features of the electronic device 10. The display 14 also may be used to visually display content received by the electronic device 10 and/or retrieved from a memory 16 (FIG. 2) of the electronic device 10. The display 14 may be used to present images, video and other graphics to the user, such as photographs, mobile television content and video associated with games.

A keypad 18 provides for a variety of user input operations. For example, the keypad 18 may include alphanumeric keys 20 for allowing entry of alphanumeric information such as telephone numbers, phone lists, contact information, notes, text, etc. In addition, the keypad 18 may include special function keys such as a “call send” key 22 for initiating or answering a call, and a “call end” key 24 for ending or “hanging up” a call.

Special function keys also may include menu navigation device 26 to facilitate navigating through a menu displayed on the display 14. In the illustrated embodiment, the menu navigation device includes a ring that may be rocked in a plurality of directions for the user to specify a directional input and a center select key. Other exemplary embodiments of the menu navigation device 26 may include a pointing device and/or distinct navigation keys to accept directional inputs from a user.

Other function keys may include audiovisual content playback keys to start, stop and pause playback, skip or repeat tracks, and so forth. Other keys associated with the electronic device may include a volume key, an audio mute key, an on/off power key, a web browser launch key, a camera key, etc.

Keys or key-like functionality also may be embodied as a touch screen associated with the display 14.

Also, the display 14 and keypad 18 may be used in conjunction with one another to implement soft key functionality. In the illustrated embodiment, a first soft key button 28a and a second soft key button 28b are present.

The electronic device 10 includes call circuitry that enables the electronic device 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 16, executing applications to allow user interaction with the data, displaying video and/or image content associated with the data, outputting audio sounds associated with the data, and so forth.

FIG. 2 represents a functional block diagram of the electronic device 10. For the sake of brevity, many features of the electronic device 10 will not be described in great detail. The electronic device 10 includes a primary control circuit 30 that is configured to carry out overall control of the functions and operations of the electronic device 10. The control circuit 30 may include a processing device 32, such as a central processing unit (CPU), microcontroller or microprocessor. The processing device 32 executes code stored in a memory (not shown) within the control circuit 30 and/or in a separate memory, such as the memory 16, in order to carry out operation of the electronic device 10. The memory 16 may be, for example, one or more of a buffer, a flash memory, a hard drive, a removable media, a volatile memory, a non-volatile memory, a random access memory (RAM), or other suitable device. In a typical arrangement, the memory 16 may include a non-volatile memory (e.g., a NAND or NOR architecture flash memory) for long term data storage and a volatile memory that functions as system memory for the control circuit 30. The volatile memory may be a RAM implemented with synchronous dynamic random access memory (SDRAM), for example. The memory 16 may exchange data with the control circuit 30 over a data bus. Accompanying control lines and an address bus between the memory 16 and the control circuit 30 also may be present.

In addition, the processing device 32 may execute code that implements the media application 12. It will be apparent to a person having ordinary skill in the art of computer programming, and specifically in application programming for mobile telephones or other electronic devices, how to program a electronic device 10 to operate and carry out logical functions associated with the media application 12. Accordingly, details as to specific programming code have been left out for the sake of brevity. Also, while the media application 12 is executed by the processing device 32 in accordance with an embodiment, such functionality could also be carried out via dedicated hardware or firmware, or some combination of hardware, firmware and/or software.

Continuing to refer to FIGS. 1 and 2, the electronic device 10 includes an antenna 34 coupled to a radio circuit 36. The radio circuit 36 includes a radio frequency transmitter and receiver for transmitting and receiving signals via the antenna 34. The radio circuit 36 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 34 and the radio circuit 36 may represent one or more than one radio transceiver.

The electronic device 10 further includes a sound signal processing circuit 38 for processing audio signals transmitted by and received from the radio circuit 36. Coupled to the sound processing circuit 38 are a speaker 40 and a microphone 42 that enable a user to listen and speak via the electronic device 10. The radio circuit 36 and sound processing circuit 38 are each coupled to the control circuit 30 so as to carry out overall operation. Audio data may be passed from the control circuit 30 to the sound signal processing circuit 38 for playback to the user. The audio data may include, for example, audio data from an audio file stored by the memory 16 and retrieved by the control circuit 30, or received audio data such as in the form of streaming audio data from a mobile radio service. The sound processing circuit 38 may include any appropriate buffers, decoders, amplifiers and so forth.

The display 14 may be coupled to the control circuit 30 by a video processing circuit 44 that converts video data to a video signal used to drive the display 14. The video processing circuit 44 may include any appropriate buffers, decoders, video data processors and so forth. The video data may be generated by the control circuit 20, retrieved from a video file that is stored in the memory 16, derived from an incoming video data stream that is received by the radio circuit 36 or obtained by any other suitable method.

The electronic device 10 may further include one or more I/O interface(s) 46. The I/O interface(s) 46 may be in the form of typical mobile telephone I/O interfaces and may include one or more electrical connectors. As is typical, the I/O interface(s) 46 may be used to couple the electronic device 10 to a battery charger to charge a battery of a power supply unit (PSU) 48 within the electronic device 10. In addition, or in the alternative, the I/O interface(s) 46 may serve to connect the electronic device 10 to a headset assembly (e.g., a personal handsfree (PHF) device) that has a wired interface with the electronic device 10. Further, the I/O interface(s) 46 may serve to connect the electronic device 10 to a personal computer or other device via a data cable for the exchange of data. The electronic device 10 may receive operating power via the I/O interface(s) 46 when connected to a vehicle power adapter or an electricity outlet power adapter. The PSU 48 may supply power to operate the electronic device 10 in the absence of an external power source.

The electronic device 10 also may include a system clock 50 for clocking the various components of the electronic device 10, such as the control circuit 30 and the memory 16.

The electronic device 10 may include a camera 52 for taking digital pictures and/or movies. Image and/or video files corresponding to the pictures and/or movies may be stored in the memory 16.

The electronic device 10 also may include a position data receiver 54, such as a global positioning system (GPS) receiver, Galileo satellite system receiver or the like. The position data receiver 54 may be involved in determining the location of the electronic device 10.

The electronic device 10 also may include a local wireless interface 56, such as an infrared transceiver and/or an RF interface (e.g., a Bluetooth interface), for establishing communication with an accessory, another mobile radio terminal, a computer or another device. For example, the local wireless interface 56 may operatively couple the electronic device 10 to a headset assembly (e.g., a PHF device) in an embodiment where the headset assembly has a corresponding wireless interface.

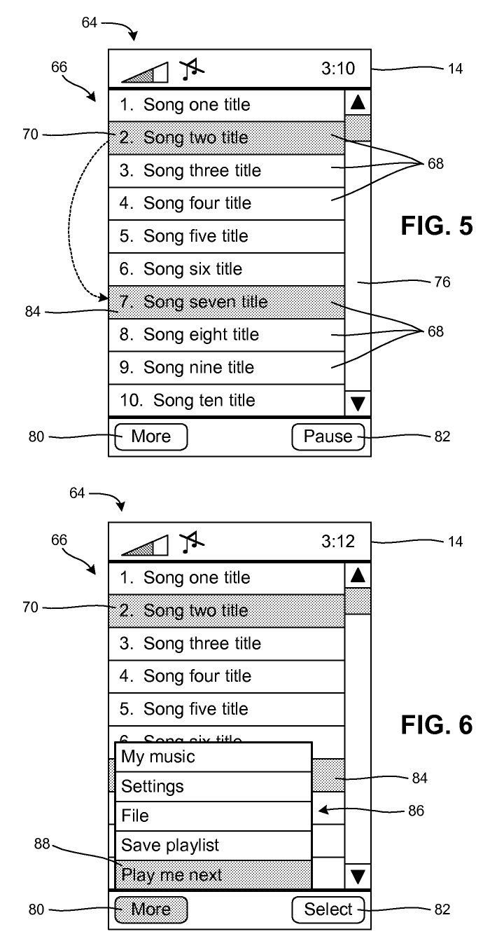

With additional reference to FIG. 3, the electronic device 10 may be configured to operate as part of a communications system 58. The system 58 may include a communications network 60 having a server 62 (or servers) for managing calls placed by and destined to the electronic device 10, transmitting data to the electronic device 10 and carrying out any other support functions. The server 62 communicates with the electronic device 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 60 may support the communications activity of multiple electronic devices 10 and other types of end user devices. As will be appreciated, the server 62 may be configured as a typical computer system used to carry out server functions and may include a processor configured to execute software containing logical instructions that embody the functions of the server 62 and a memory to store such software.

As indicated, the media application 12 may be used to implement the functions associated with a playback selection feature of the electronic device 10, also referred to as a “play selection next” feature. The following portion of the description describes an exemplary implementation of the playback selection feature.

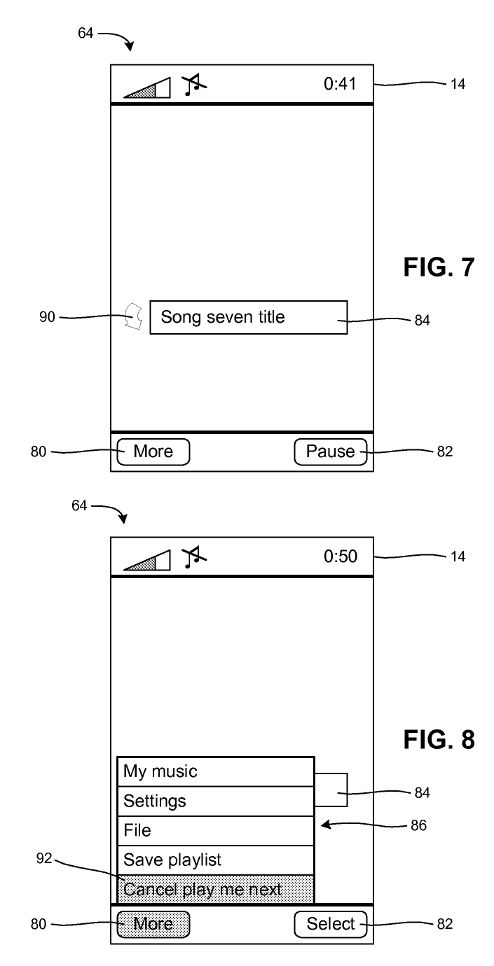

With additional reference to FIG. 4, shown is a “now playing” screen shot 64 that is displayed on the display 14. The now playing screen shot 64 may be generated under the control of the media application 12. The now playing screen shot 64 may include a playlist 66 that contains a list of audiovisual content entries 68. In the illustrated example, the entries 68 each relate to a song. The playlist 66 may be constructed in any conventional manner, such as selecting songs from a database or file structure, and adding the songs to the playlist 66. Each song may be embodied as a corresponding file that is stored by the memory 16, for example. The entries 68 of the playlist 66 may identify the corresponding songs by a text identifier and/or with a graphic. For instance, in the illustrated example, the playlist 66 identifies songs by title of the song. The displayed information may be derived from metadata or header information stored in association with the file for the song, from the filename associated with the file, or other appropriate source. In one operational mode, the songs may be played back in the sequential order in which the songs are listed in the playlist 66. In the sequential playback mode, the displayed playlist 66 corresponds to a song playback queue. In another operational mode, the songs may be played back in a random order as determined by the media application 12. The random playback order may be identified as part of the now playing screen shot 64 or not revealed to the user. In the illustrated embodiment, the entry 68 for the song presently undergoing playback is highlighted and will be referred to as the current entry 70.

The now playing screen shot 64 may include additional information and/or user interface features. Features present in the exemplary now playing screen shot 64 include a volume setting graphic 72, an audio mute graphic 74, a scroll bar 76, and a playtime graphic 78 (e.g., to indicate elapsed playtime or remaining playtime for the current entry 70 and/or to indicate elapsed playtime or remaining playtime for the playlist 66). Other information and/or user interfaces in addition to or instead of the illustrated items may be displayed.

The exemplary now playing screen shot 64 may include a pair of soft key icons 80 and 82 that may indicate user interactive functions that are available by depression of corresponding keys from the keypad 18. In the illustrated example, the function of soft key icon 80 may be accessed by depression of key 28a and the function of soft key icon 82 may be accessed by depression of key 28b. During playback of songs from the playlist 66, the soft key icon 80 may relate to “more” options offered by the media application 12. That is, depression of the key 28a corresponding to the soft key icon 80 may result in the display of a menu with a list of menu choices. Some of these options will be described in greater detail below. Also, during playback of the songs from the playlist 66, the soft key icon 82 may relate to a “pause” command to temporarily stop playback of the current song 68 or may be associated with some other command. The function associated with each soft key icon 80, 82 and the text or graphic displayed in the soft key icon 80, 82 may change depending on the operating state of the media application 12. For instance, if the playback were in a paused state, the soft key icon 82 may become associated with a play or resume function.

With additional reference to FIG. 5, the user may commence operation of the playback selection feature by using the navigation device 26 or other user input device to scroll to a desired playlist entry 68, which will be referred to as a target entry 84. The target entry 84 is the item of audiovisual content that the user would like to hear or view next. In the example, the target entry 84 is the song that the user would like to hear next, after playback of the current entry 70 ends.

The dashed arrow in FIG. 5 represents the scrolling operation. As the scrolling operation takes place, the song entry 68 associated with the current position of the user input navigation device 26 may be highlighted. In the illustrated example, the user has undertook action to command a scrolling to the seventh song title in the playlist 66 and this entry is highlighted. The current entry 70 may remain highlighted and playing during the scrolling operation. The scrolling to the target entry 84 may be considered an act of identifying a target entry 84 for playback after the playback of the currently playing entry 70 ends. As will be appreciated, other techniques to identify an entry from the playlist 66 as the target entry 84 are possible, such as by using a touch sensitive interface, keying in the displayed title, and so forth.

With additional reference to FIG. 6, after the target entry 84 is identified, the target entry 84 may be selected for playback as the next entry to be played back. Selection as the next entry for playback will override any queue or randomization that is otherwise scheduled to take place by normal operation of playing back audiovisual content from the playlist 66.

In the illustrated example, selection of the identified target entry 84 may occur as follows. With the target entry 84 identified (e.g., highlighted), the user may depress the key 28a associated with the soft key icon 80 to invoke display of a menu 86. The menu 86 may present various menu options including an option 88 to select the target entry 84 for playback. In the illustrated example, the option 88 is identified with the text “play me next.” This text, or similar text, may indicate to the user that selection of this menu option 88 will result in playing back of the identified target entry 84 as if the target entry 84 were next in the sequential queue for playback or the random order for playback, regardless of where in the queue or random order the target entry 84 ordinarily falls. The option 88 may be selected by scrolling to the option 88 (if not already highlighted) and pressing a select key. In one embodiment, selection of the key 28a to display the menu 86 may result in the key 28b becoming the select key along with a corresponding change in the soft key icon 82, as illustrated. In another embodiment, a central key of the navigation device 26 or some other enter key may be used as the select key. Other ways to input a select command may include, for example, use of a mouse pointer and a mouse button, use of a voice command, and so forth.

Selection of the identified target entry 84 for playback as the next entry to be played back may be made in manners other than by using a menu. For instance, following the identification of an entry 68 other than the current entry 70 as the target entry 84, one of the soft keys 28a or 28b may directly correspond to the command to select the target entry 84 for playback following playback of the current entry 70.

In a preferred embodiment, selection of the identified target 84 does not terminate playback of the current entry 70. Rather, after the target entry 84 has been identified and selected as the next entry for play back, playback of the current entry 70 may continue. After the entirety of the current entry 70 is played out, then playback of the target entry 84 may be carried out.

With additional reference to FIG. 7, during playback of the target entry 84, the identity of the target entry 84 may be displayed on the display 14. Also, an icon 90 may be displayed next to the identification of the target entry 84 instead of or in addition to a playlist entry number that would otherwise normally appear next to the identifying subject matter. The icon 90 may graphically represent that the playing item (the target entry 84) was selected for playback using the “play selection next” feature as described above. As shown in the example of FIG. 7, the other entries 68 may be removed from the display. Alternatively, the other entries 68 may be displayed with less than full color saturation to appear in a faded form or without any change. For example, the playlist 66 may be displayed in its normal form, but the icon 90 may be added next to the target entry 84.

Playback of the target entry 84 may continue until the target entry 84 has been fully played out. At that point, the playback of entries 68 may continue as if the target entry has not been played. For instance, the entry 68 sequentially after or in the random order after the current entry 70 may be played. In another embodiment, the entry 68 sequentially after or in the random order after the target entry 84 may be played, which would effectively skip the entries 68 between the current entry 70 and the target entry 84. In other embodiment, the user may have made another “play selection next” choice during the playback of the previously selected target entry 84. In this case, the new target entry 84 may be played out after playback of the previous target entry 84 is complete.

After the target entry 84 is played and playback of playlist 66 returns to the normal playback order (e.g., starting with the entry after the current entry 70 or the target entry 84), the played target entry 84 may remain in the playback list. Alternatively, the played target entry 84 may be skipped in the ensuing playback order.

With additional reference to FIG. 8, playback of a currently playing target entry 84 may be cancelled by user action. For instance, the menu 86 may be displayed by appropriate keypad 18 operation, such as by depression of the key 28a corresponding to the soft key icon 80. In this operational state, the menu option 88 (FIG. 6) to select the target entry 84 for playback may be changed to a cancel menu option 92. Selection of the cancel menu option 92 may immediately end playback of the target entry 84 and commence playing back of entries 68 from the playlist 66 in the normal sequential or random playback order (e.g., starting with the entry after the current entry 70 or the target entry 84).

In addition to the playback selection feature that has been described above, the user may be provided with menu options and/or keys to skip an entry 68 from the playlist 66 or to repeat an entry 68 from the playlist 66.

Although certain embodiments have been shown and described, it is understood that equivalents and modifications falling within the scope of the appended claims will occur to others who are skilled in the art upon the reading and understanding of this specification.

What is claimed is:

1. A method of controlling playback of audiovisual content using an electronic device, comprising:
displaying a playlist having a plurality of entries that are each associated with an item of audiovisual content and wherein one of the items of audiovisual content is undergoing current playback;
receiving user input to identify and select a target entry from the playlist; and
immediately following completion of the playback of the currently playing item of audiovisual content, playing back the item of audiovisual content associated with the target entry.

2. The method of claim 1, further comprising:
completing playback of the item of audiovisual content associated with the target entry; and
playing back additional items of audiovisual content that correspond to entries from the playlist after playback of the item of audiovisual content associated with the target entry.

3. The method of claim 2, wherein the playback of additional items of audiovisual content starts with an item of audiovisual content having an associated playlist entry that falls in a predetermined playback order of the playlist immediately after the entry corresponding to the item of audiovisual content played before the item of audiovisual content associated with the target entry was played.

4. The method of claim 3, wherein the predetermined playback order is a sequential queue.

5. The method of claim 3, wherein the predetermined playback order is a random order.

6. The method of claim 2, wherein the playback of additional items of audiovisual content starts with an item of audiovisual content having an associated playlist entry that falls in a predetermined playback order of the playlist immediately after the target entry.

7. The method of claim 2, wherein during playback of the additional items of audiovisual content, the item of audiovisual content associated with the target entry is skipped from playback.

8. The method of claim 1, further comprising displaying a menu with a menu option to play the identified entry next as a means for the user to make the selection.

9. The method of claim 1, further comprising cancelling playback of the item of audiovisual content associated with the target entry following receipt of user input to command the cancelling.

10. A program stored on a machine readable medium, the program for controlling playback of audiovisual content using an electronic device and the program comprising:
logic to control the display of a playlist, the playlist having a plurality of entries that are each associated with an item of audiovisual content;
logic to receive user input to identify and select a target entry from the playlist during playback of one of the items of audiovisual content; and
logic to control the playback of the items of audiovisual content so that immediately following completion of the playback of the currently playing item of audiovisual content, the item of audiovisual content associated with the target entry is played back.

11. The program of claim 10, further comprising:
logic to complete playback of the item of audiovisual content associated with the target entry; and
logic to control the playback of additional items of audiovisual content that correspond to entries from the playlist after playback of the item of audiovisual content associated with the target entry.

12. The program of claim 10, further comprising logic to display a menu with a menu option to play the identified entry next as a means for the user to make the selection.

13. An electronic device, comprising:
a display; and
a control circuit that is configured to control playback of audiovisual content, including:
control the display of a playlist on the display, the playlist having a plurality of entries that are each associated with an item of audiovisual content;
receive user input to identify and select a target entry from the playlist during playback of one of the items of audiovisual content; and
control the playback of the items of audiovisual content so that immediately following completion of the playback of the currently playing item of audiovisual content, the item of audiovisual content associated with the target entry is played back.

14. The electronic device of claim 13, further comprising call circuitry to establish a call over a network.

15. The electronic device of claim 13, wherein the control circuit is further configured to complete playback of the item of audiovisual content associated with the target entry and control the playback of additional items of audiovisual content that correspond to entries from the playlist after playback of the item of audiovisual content associated with the target entry.

16. The electronic device of claim 13, wherein the control circuit is further configured to display a menu with a menu option to play the identified entry next as a means for the user to make the selection.

17. A method of controlling playback of audiovisual content using an electronic device, comprising:
identifying a target entry from a displayed playlist, the playlist having a plurality of entries that are each associated with an item of audiovisual content and wherein one of the items of audiovisual content is undergoing current playback; and
selecting the target entry for immediate playback after playback of the currently playing item of audiovisual content concludes.
